SEQUENCE LISTING (5 sequences)

SEQ ID NO: 1 - protein, 616 aa, Penicillium oxalicum
MRLTLLSGVAGVLCAGQLTAARPDPKGGNLTPFIHKEGERSLQGILDNLGGRGKKTPGTAAGLFIASPNTENPNYYYTWTRDSALTAKCLIDLFEDSRAKFPIDRKYLETGIRDYVSSQAILQSVSNPSGTLKDGSGLGEPKFEIDLNPFSGAWGRPQRDGPALRATAMITYANYLISHGQKSDVSQVMWPIIANDLAYVGQYWNNTGFDLWEEVDGSSFFTIAVQHRALVEGSQLAKKLGKSCDACDSQPPQILCFLQSFWNGKYITSNINTQASRSGIDLDSVLGSIHTFDPEAACDDATFQPCSARALANHKVYVDSFRSIYKINAGLAEGSAANVGRYPEDVYQGGNPWYLATLGASELLYDALYQWDRLGKLEVSETSLSFFKDFDATVKIGSYSRNSKTYKKLTQSIKSYADGFIQLVQQYTPSNGSLAEQYDRNTAAPLSANDLTWSFASFLTATQRRDAVVPPSWGAKSANKVPTTCSASPVVGTYKAPTATFSSKTKCVPAKDIVPITFYLIENTYYGENVFMSGNITALGNWDAKKGFPLTANLYTQDQNLWFASVEFIPAGTPFEYKYYKVEPNGDITWEKGPNRVFVAPTGCPVQPHSNDVWQF

SEQ ID NO: 2 - protein, 593 aa, Talaromyces emersonii
ATGSLDSFLATETPIALQGVLNNIGPNGADVAGASAGIVVASPSRSDPNYFYSWTRDAALTAKYLVDAFNRGNKDLEWEQTIQQYISAQAKVQTISNPSGDLSTGGLGEPKFNVNETAFTGPWGRPQRDGPALRATALIAYANYLIDNGEASTADEIIWPIVQNDLSYITQYWNSSTFDLWEEVEGSSFFTTAVQHRALVEGNALATRLNHTCSNCVSQAPQVLCFLQSYWTGSYVLANFGGSGRSGKDVNSILGSIHTFDPAGGCDDSTFQPCSARALANHKVVTDSFRSIYAINSGIAEGSAVAVGRYPEDVYQGGNPWYLATAAAAEQLYDAIYQWKKIGSISITDVSLPFFQDIYPSAAVGTYNSGSTTFNDIISAVQTYGDGYLSIVEKYTPSDGSLTEQFSRTDGTPLSASALTWSYASLLTASARRQSVVPASWGESSASSVLAVCSATSATGPYSTATNTVWPSSGSGSSTTTSSAPCTTPTSVAVTFDEIVSTSYGETIYLAGSIPELGNWSTASAIPLRADAYTNSNPLWYVTVNLPPGTSFEYKFFKNQTDGTIVWEDDPNRSYTVPAYCGQTTAILDDSWQ

SEQ ID NO: 3 - protein, 640 aa, Aspergillus niger
MSFRSLLALSGLVCTGLANVISKRATLDSWLSNEATVARTAILNNIGADGAWVSGADSGIVVASPSTDNPDYFYTWTRDSGLVLKTLVDLFRNGDTSLLSTIENYISAQAIVQGISNPSGDLSSGAGLGEPKFNVDETAYTGSWGRPQRDGPALRATAMIGFGQWLLDNGYTSTATDIVWPLVRNDLSYVAQYWNQTGYDLWEEVNGSSFFTIAVQHRALVEGSAFATAVGSSCSWCDSQAPEILCYLQSFWTGSFILANFDSSRSGKDANTLLGSIHTFDPEAACDDSTFQPCSPRALANHKEVVDSFRSIYTLNDGLSDSEAVAVGRYPEDTYYNGNPWFLCTLAAAEQLYDALYQWDKQGSLEVTDVSLDFFKALYSDAATGTYSSSSSTYSSIVDAVKTFADGFVSIVETHAASNGSMSEQYDKSDGEQLSARDLTWSYAALLTANNRRNSVVPASWGETSASSVPGTCAATSAIGTYSSVTVTSWPSIVATGGTTTTATPTGSGSVTSTSKTTATASKTSTSTSSTSCTTPTAVAVTFDLTATTTYGENIYLVGSISQLGDWETSDGIALSADKYTSSDPLWYVTVTLPAGESFEYKFIRIESDDSVEWESDPNREYTVPQACGTSTATVTDTWR

SEQ ID NO: 4 - protein, 556 aa, Trametes cingulata
QSSAADAYVASESPIAKAGVLANIGPSGSKSNGAKAGIVIASPSTSNPNYLYTWTRDSSLVFKALIDQFTTGEDTSLRTLIDEFTSAEAILQQVPNPSGTVSTGGLGEPKFNIDETAFTDAWGRPQRDGPALRATAIITYANWLLDNKNTTYVTNTLWPIIKLDLDYVASNWNQSTFDLWEEINSSSFFTTAVQHRALREGATFANRIGQTSVVSGYTTQANNLLCFLQSYWNPTGGYITANTGGGRSGKDANTVLTSIHTFDPAAGCDAVTFQPCSDKALSNLKVYVDAFRSIYSINSGIASNAAVATGRYPEDSYMGGNPWYLTTSAVAEQLYDALIVWNKLGALNVTSTSLPFFQQFSSGVTVGTYASSSSTFKTLTSAIKTFADGFLAVNAKYTPSNGGLAEQYSRSNGSPVSAVDLTWSYAAALTSFAARSGKTYASWGAAGLTVPTTCSGSGGAGTVAVTFNVQATTVFGENIYITGSVPALQNWSPDNALILSAANYPTWSSTVNLPASTTIEYKYIRKFNGAVTWESDPNNSITTPASGTFTQNDTWR

SEQ ID NO: 5 - protein, 512 aa, Bacillus stearothermophilus
AAPFNGTMMQYFEWYLPDDGTLWTKVANEANNLSSLGITALWLPPAYKGTSRSDVGYGVYDLYDLGEFNQKGAVRTKYGTKAQYLQAIQAAHAAGMQVYADVVFDHKGGADGTEWVDAVEVNPSDRNQEISGTYQIQAWTKFDFPGRGNTYSSFKWRWYHFDGVDWDESRKLSRIYKFRGKAWDWEVDTEFGNYDYLMYADLDMDHPEVVTELKSWGKWYVNTTNIDGFRLDAVKHIKFSFFPDWLSDVRSQTGKPLFTVGEYWSYDINKLHNYIMKTNGTMSLFDAPLHNKFYTASKSGGTFDMRTLMTNTLMKDQPTLAVTFVDNHDTEPGQALQSWVDPWFKPLAYAFILTRQEGYPCVFYGDYYGIPQYNIPSLKSKIDPLLIARRDYAYGTQHDYLDHSDIIGWTREGVTEKPGSGLAALITDGPGGSKWMYVGKQHAGKVFYDLTGNRSDTVTINSDGWGEFKVNGGSVSVWVPRKTTVSTIAWSITTRPWTDEFVRWTEPRLVAW

(19) United States
(12) Patent Application Publication
(10) Pub. No.: US 2015/0275158 A1
(43) Pub. Date: Oct. 1, 2015

(54) Method for Production of Brewers Wort

(71) Applicant: NOVOZYMES A/S, Bagsvaerd (DK)

(72) Inventors: Hans Peter Heldt-Hansen, Virum (DK); Chee Leong Soong, Raleigh, NC (US)

(21) Appl. No.: 14/436,336

(22) PCT Filed: Oct. 16, 2013
(86) PCT No.: PCT/EP2013/071624

§ 371 Date: Apr. 16, 2015

(30) Foreign Application Priority Data
Oct. 17, 2012 (EP) 12188799.6
May 3, 2013 (EP) 13166418.7

(51) Int. Cl. C12C 7/04; C12C 5/00

(52) U.S. Cl. CPC C12C 7/04; C12C 5/004

(57) ABSTRACT

The present invention relates to a method for production of brewer's wort comprising adding to a mash, a particular glucoamylase. Furthermore, the invention relates to use of a combination of a glucoamylase and an alpha amylase for production of brewer's wort.

### REFERENCE TO A SEQUENCE LISTING

This application contains a Sequence Listing in computer readable form. The computer readable form is incorporated herein by reference.

### FIELD OF INVENTION

The present invention in general relates to method for production of brewers wort. Particularly the present invention relates to a method for production of brewers wort by adding a glucoamylase.

### BACKGROUND OF THE INVENTION

In modern mashing processes, enzymes are often added as a supplement when mashing malt is low in enzymes or to allow use of all adjunct grists. Enzymes may also be applied in mashing of well modified malts with high enzyme content in order to increase the extract recovery as well as the amount of fermentable sugars.

U.S. Pat. No. 3,379,534 describes preparation of a low dextrin beer by using an amyloglucosidase. U.S. Pat. No. 4,536,477 describes a thermostable glucoamylase especially useful for preparation of glucose containing syrups from starch.

WO 2009/075682 describes the use of a pullulanase to produce a brewers wort where mashing is achieved using a smaller amount of enzyme protein.

Matthews et al., 2001, Journal of Institute of brewing 107(3) pp 185-194 discloses preparation of a low carbohydrate beer by mashing at high temperature with a glucoamylase, which is derived from Aspergillus niger.

WO2007113292 describes a process of mashing wherein mashing-in of corn and rice adjunct is done to obtain a maltose based wort which is not high in attenuation.

Though traditionally beer has been brewed from just barley malt, hops and water, malt is an expensive raw material because it requires superior quality grains, water for germination, and energy for kilning/roasting. Traditionally around 30-60% of unmalted grains, also called adjuncts, such as maize, rice, sorghum, and wheat, refined starch or readily fermentable carbohydrates such as sugar or syrups are also included in the grist.

Adjuncts in high attenuated beers are used partly because they are readily available and provide carbohydrates at a lower cost than is available from barley malt, and partly because they are important for the flavor and body characteristics of high attenuated beers. Other advantages may also be achieved, e.g., enhanced physical stability, superior chill-proof qualities, and greater brilliancy. However when adjuncts with higher gelatinization temperatures, for example, maize or rice are used, they are usually cooked and gelatinized in a separate “cereal cooker” before being mixed into the malt mash ahead of saccharification.

Thus, while the use of adjunct reduces the costs of raw material price, it requires an additional investment in the cereal cooker as well as an additional cost for energy for heating the adjunct. These additional expense requirements have discouraged brewers from increasing the adjunct ratio and also use different adjuncts of choice in their brewing process. Of late, there is a dramatic changing in energy and raw material prices caused by increased demand for grains, global water shortage, changing weather patterns etc. This has forced the brewing industry to focus on production efficiency as well as raw material savings.

There exists a need for improved processes in brewing which will bring down costs and/or increase production efficiency.

### SUMMARY OF THE INVENTION

The present inventors have surprisingly found that by use of a glucoamylase, mashing can be achieved using starch adjuncts that are ungelatinized.

Accordingly, in one aspect, the invention relates to a method of producing a brewer's wort comprising
a. Providing a grist comprising a starch source with ungelatinized starch with a gelatinization temperature above 68° C.;
b. adding to a mash comprising the grist, a glucoamylase that has at least 10% residual activity at 80° C., and
c. obtaining a wort.

Accordingly, in another aspect, the invention relates to a method of producing a brewer's wort comprising
a. providing a grist comprising a starch source with ungelatinized starch with a gelatinization temperature above 68° C.;
b. adding to a mash comprising the grist, a glucoamylase that is still active during lautering and that has at least 10% residual activity at 80° C., and
c. obtaining a wort.

Accordingly, in another aspect, the invention relates to a method of producing a brewer's wort comprising
a. providing a grist comprising a starch source with ungelatinized starch with a gelatinization temperature of at least 67° C.;
b. adding to a mash comprising the grist, a glucoamylase that has at least 10% residual activity at 80° C., and
c. obtaining a wort.
   In one embodiment, the mashing is done below the gelatinization temperature of the ungelatinized starch and mashing off is done above the gelatinization temperature.
   In one aspect, the grist further comprises malt.
   In one embodiment, the grist comprises at least 25% W/W of the ungelatinized starch.
   In various embodiments, the ungelatinized starch is selected from corn, rice or sorghum or mixtures thereof.
   In one embodiment, the glucoamylase is at least 50% identical to SEQ ID NO: 1.
   In a preferred aspect, the glucoamylase is dosed in less than 5 AGU/g grist.
   In one embodiment, the method further comprises adding an alpha amylase.
   In a preferred aspect, the alpha-amylase has at least 10% residual activity at 75° C.
   In another preferred aspect, the alpha-amylase is at least 50% identical to SEQ ID NO: 5.
   In various embodiments, the resulting wort has either more than 70% glucose or less than 20% dextrins (DP4+) or both.
   In one aspect, the mashing profile includes a rest at a temperature above 70° C.
   In one embodiment, the total mashing time is less than 181 min.
   In one aspect, the pH of the mash is from 4.6 to about 6.4.
   In one embodiment, the glucoamylase has a temperature optimum of above 65° C.
   In various embodiments, the method further comprises adding an enzyme selected from group consisting of a pullulanase, a protease, a xylanase, a lipase, a cellulase, an amylase, and a beta glucanase; and combinations thereof.
   In one aspect, the wort is further fermented to obtain an alcoholic beverage.
   In one embodiment, the alcoholic beverage is a beer.
   In one aspect, the glucoamylase is active under mashing-off.
   In one aspect, the glucoamylase is added at the beginning of mashing.
   In another aspect, the glucoamylase is added during mashing.
   In one aspect, the glucoamylase is added during lautering.
   In another aspect, the glucoamylase addition is done at a temperature between 65° C. and 90° C.
   In one aspect, the glucoamylase is obtained from Penicillium.
   In another aspect, the glucoamylase is obtained from Penicillium oxalicum.

### DETAILED DESCRIPTION OF THE INVENTION

Brewing processes are well-known in the art, and generally involve the steps of malting, mashing, and fermentation. Mashing is the process of converting starch from the milled barley malt and solid adjuncts into fermentable and un-fermentable sugars to produce a wort of the desired composition.

Traditional mashing involves mixing milled barley malt and adjuncts with water at a set temperature and volume to continue the biochemical changes initiated during the malting process. The mashing process is conducted over a period of time at a constant temperature (isothermal mashing) or gradually increased, for example, in a sequential manner to various temperatures in order to activate the endogenous enzymes responsible for the degradation of proteins and carbohydrates. By far the most important change brought about in mashing is the liberation of soluble substances in the malt/barley/adjuncts into the liquid fraction, and the conversion of starch molecules into fermentable sugars.

The principal enzymes responsible for starch conversion in a traditional mashing process are alpha-amylases, beta-amylases and dextranases. Alpha-amylase very rapidly reduces insoluble and soluble starch by splitting starch molecules into many shorter chains that can be attacked by beta-amylase. The disaccharide produced is maltose. In addition to the maltose formed during mashing short branched glucose oligomers are produced. The short branched glucose oligomers are non-fermentable sugars and add to the taste as well as the amount of calories of the finished beer.

After mashing, when all the starch has been broken down, it is necessary to separate the liquid extract (the wort) from the residual solids (spent grains) for example, by filtration. Wort separation, lautering, is important because the solids contain large amounts of protein, poorly modified starch, fatty material, silicates, and polyphenols (tannins). Prior to lautering, the mash temperature may be raised to about 75-78° C. (known as mashing-off). The wort thus obtained may also be denoted “first wort”.

The extract retained in the spent grain after collection of the first wort may also be washed out by adding hot water on top of the lauter cake. This process is called sparging. The hot water flows through the spent grain and dissolves the remaining extract. The diluted wort is called second wort, and its extract decreases from the original gravity of the first wort down to 1-2%.

Non-limiting examples of suitable procedures for preparation of wort is described for example, by Briggs et al., “Malting and brewing science, Volume I Malt and sweet wort”, Chapman and Hall, New York, USA, ISBN 0412165805 (1981) and Hough et al., “Malting and brewing science, Volume II Hopped wort and beer”, Chapman and Hall, New York, USA, ISBN 0412165902 (1981). After addition of hops, the wort is boiled. Hereby numerous substances including several proteins are denatured and a precipitation of polyphenols will take place. After cooling and removal of precipitates, the finished wort may be aerated and fermented with brewer's yeast to produce a beer.

After a main fermentation, lasting typically 5-10 days, most of the yeast is removed and the green beer is obtained. The green beer is stored at a low temperature, typically at 0-5° C. for 1 to 12 weeks. During this period, the remaining yeast will precipitate together with polyphenols. To remove the remaining excess polyphenols, a filtration is performed to obtain the fermented beer. The fermented beer may be carbonized prior to bottling. Carbon dioxide not only contributes to the perceived “fullness” or “body” and as a flavor enhancer, it also acts as an enhancer of the foaming potential and plays an important role in extending the shelf life of the product. Further information on conventional brewing processes may be found in “Technology Brewing and Malting” by Wolfgang Kunze of the Research and Teaching Institute of Brewing, Berlin (VLB), 2nd revised Edition 1999, ISBN 3-921690-39-0.

In one aspect, the present invention provides a method to produce low carbohydrate content (low carb) beers. A typical wort consists of a mixture of starch derived carbohydrates which are classified as fermentable or non-fermentable according to whether they can be converted into ethanol by brewer's yeast. In traditional mashing, the fermentable carbohydrates are formed by hydrolysis of grain starch by malt alpha- and beta-amylases. Starch is a glucose polymer in which the glucose residues are linked by either alpha-1,4 bonds or alpha-1,6 bonds. During the mashing cycle the starch is first solubilized and then a portion of the starch molecules are hydrolyzed into non-fermentable dextrins and to low molecular weight sugars, such as glucose, maltose and maltotriose, which brewer's yeast can ferment into ethanol. The dextrin fraction consists of all sugars with a higher degree of polymerisation (DP) than maltotriose, contributes by far the majority of the unfermentable starch degradation products (besides the dextrin fraction also isomaltose, panonase and isopanose are unfermentable). The composition of the wort can vary depending on the starting material, mash cycles and other variables. The carbohydrate composition of a typical, not high attenuated, wort consists of 65-80% fermentable sugars, and 20-35% non-fermentable limit dextrins. During fermentation the fermentable fraction is converted into ethanol to a final concentration of 3 to 6% w/w. The dextrins are not converted into ethanol and remains in the final beer adding to the carbohydrate content of the beverage. In the production of “low carb” or super attenuated beers, an attempt is made to obtain a higher proportion of alcohol and a lower amount of residual dextrin. Glucoamylases are often used in brewing to reduce the content of dextrins. However, as glucoamylases are much more efficient in hydrolyzing the alpha-1,4 bonds and have difficulties in hydrolyzing the alpha-1,6 bonds, they are normally used in very high concentrations.

In one aspect, the present invention provides a method suitable for producing a wort that is low in dextrins and thereby non-fermentable sugars. In another aspect, the invention relates to a method for producing a wort that is enriched in glucose. In another aspect, the invention relates to a method for producing a wort that is depleted in maltose. The method applies an expressly selected glucoamylase activity.

The inventors have surprisingly found that using glucoamylases which are active at much higher temperatures than glucoamylases normally used in brewing can provide many advantages. For example, by applying glucoamylases active at lautering, the inventors found that they can benefit from not only the traditional saccharification step but also during the rest of the lautering process. This therefore reduced the amount of glucoamylase to reach the same RDF (Real Degree of Fermentation). Alternatively using the method of the invention, one can even obtain higher RDF values and/or one can reduce the saccharification time at 60-66° C. The inventors also found that having a glucoamylase active at higher temperature enabled mashing in of adjuncts where the starch has a high gelatinization temperature, such as corn, rice and sorghum. A high level of starch hydrolysis of such adjuncts will be ensured as the glucoamylase is active when the starch is gelatinized.

The inventors also found that further efficiency will be obtained by addition of an alpha amylase, for example, an alpha amylase that has at least 10% residual activity at 75° C., and using a holding step during mashing where the starch of the adjuncts is gelatinized and where the glucoamylase is active. The holding step might be just before lautering (called mashing off) or might be placed earlier, the temperature might be lower, equal or even higher than the lautering temperature, which is typically 75-80° C.

### DEFINITIONS

Throughout this disclosure, various terms that are generally understood by those of ordinary skill in the arts are used. Several terms are used with specific meaning, however, and are meant as defined by the following.

As used herein, “a” can mean one or more, depending on the context in which it is used.

As used herein the term “grist” is understood as the starch or sugar containing material that is the basis for beer production, for example, but not limited to the barley malt and the adjunct. Generally, the grist does not contain any added water.

The term “malt” is understood as any malted cereal grain, in particular barley.

The term “adjunct” is understood as the part of the grist which is not malt. The adjunct may be any starch rich plant material such as, but not limited to un-malted grain, barley, corn, rice, sorghum, wheat and also includes readily fermentable sugar and/or syrup. The starch of some of the adjuncts has a relatively low gelatinization temperature which enable them to be mashed in together with the malt, whereas other adjuncts such as rice, corn and sorghum has a higher gelatinization temperature, such adjuncts are typically separately cooked and liquefied with an alpha-amylase before they are added to the mash. Preferred adjuncts for the invention include adjuncts where the starch has a higher onset, peak, and conclusion gelatinization temperature (To, Tp, Tc) than barley or malt, more preferably above 5° C. higher than malt starch. The adjuncts can be gelatinized prior to mashing or they can be added as such to the grist.

In one aspect, the adjuncts are not gelatinized prior to mashing.

The term “mash” is understood as a starch containing slurry comprising crushed barley malt, crushed unmalted grain, other starch containing material, or a combination hereof, steeped in water to make wort. “Mashing” is the process of converting starch in the mash into fermentable and un-fermentable sugars.

The term “wort” is understood as the unfermented liquor run-off following extracting the grist during mashing.

The term “spent grains” is understood as the drained solids remaining when the grist has been extracted and the wort separated.

The term “beer” is here understood as fermented wort, i.e., an alcoholic beverage brewed from barley malt, optionally adjunct and hops. The term “beer” as used herein is intended to cover at least beer prepared from mashes prepared from un-malted cereals as well as all mashes prepared from malted cereals, and all mashes prepared from a mixture of malted and un-malted cereals. The term “beer” also covers beers prepared with adjuncts, and beers with all possible alcohol contents.

When an aqueous solution of starch granules is heated, the granules swell to form a paste. This process is called “gelatinization”. The temperature at which gelatinization occurs is called the “gelatinization temperature”. Because of the complex nature of the starch in the adjuncts and also the conditions during mashing, the gelatinization actually occurs over a particular temperature range. The term “starch gelatinization” is understood as the irreversible order-disorder transition that starch undergoes when heated in the presence of water. Differential Scanning calorimetry (DSC) is one technique that can be employed to study the gradual process of starch gelatinization describing the onset and peak temperature (Tₒ and Tₚ) of starch gelatinization. Unless otherwise specified, the gelatinization temperature refers to the starch gelatinization temperature defined by the MEBAK method (MEBAK RAW MATERIALS, 2006, Chapter 2 Rohfrucht, 2.7 Verkleisterungstemperatur, Germany, pp 106-109).

The term “onset gelatinization temperature (Tₒ)” is understood as the temperature at which the gelatinization begins. The term “peak gelatinization temperature (Tₚ)” is understood as the temperature at endotherm peak. The term “conclusion gelatinization temperature (T_{c})” is understood as the temperature at which the gelatinization has terminated.

For example, for corn starch, the onset gelatinization temperature is approximately 62° C. (peak: 67° C., conclusion: 72° C.), and for rice starch the onset gelatinization temperature is approximately 68° C. (peak: 74.5° C., conclusion: 78° C.) (Starch, 2^{nd} ed. Industrial microscopy of starch by Eileen Maywald Snyder). For sorghum, the onset gelatinization temperature is approximately 60° C. (peak: 68° C., conclusion: 76° C.). For barley, it is approximately 56° C. (peak: approximately 64° C., conclusion: approximately 69° C.). The initial gelatinization temperature may vary according to the plant species, to the particular variety of the plant species as well as with the growth conditions.

Sequence Identity:

The relatedness between two amino acid sequences is described by the parameter “sequence identity”.

For purposes of the present invention, the sequence identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends in Genetics 16: 276-277), preferably version 5.0.0 or later. The parameters used are gap open penalty of 10, gap extension penalty of 0.5, and the EBLOSUM62 (EMBOSS version of BLOSUM62) substitution matrix. The output of Needle labeled “longest identity” (obtained using the -nobrief option) is used as the percent identity and is calculated as follows:

(Identical Residues×100)/(Length of Alignment−Total Number of Gaps in Alignment).

### Wort Production

Accordingly in one aspect, the invention relates to a method of producing a brewer's wort comprising
a. providing a grist comprising a starch source with ungelatinized starch with a gelatinization temperature above 68° C.,
b. adding to a mash comprising the grist, a glucoamylase that has at least 10% residual activity at 80° C., and
c. obtaining a wort.
   In another aspect, the invention relates to a method of producing a brewer's wort comprising
a. providing a grist comprising a starch source with ungelatinized starch with a gelatinization temperature of at least 67° C.,
b. adding to a mash comprising the grist, a glucoamylase that has at least 10% residual activity at 80° C., and
c. obtaining a wort.

In one aspect, the ungelatinized starch has a peak gelatinization temperature (Tp) of 67° C., such as above 67° C., e.g., above 68° C., e.g., above 69° C., e.g., above 70° C., e.g., above 71° C., e.g., above 72° C., e.g., above 73° C., e.g., above 74° C., e.g., above 75° C., e.g., above 76° C., e.g., above 77° C., such as for example above 78° C.

In one embodiment, the mashing is done below the gelatinization temperature of the ungelatinized starch, and where the mashing later includes a holding step above the gelatinization temperature, this holding step might be before lautering (mashing off) and may have constant or changing temperatures.

In one aspect of the invention, the gelatinization temperature is the peak gelatinization temperature.

In another aspect, the invention relates to a method of producing a brewer's wort comprising adding to a mash, a glucoamylase that is still active during lautering and has at least 10% residual activity at 80° C. as determined by the enzyme's ability to release glucose at pH 6.0 measured by the formation of glucose using maltodextrin as a substrate as described in Example 1.

In one aspect, the residual activity is measured at pH 6.0 and by the formation of glucose using maltodextrin as a substrate.

In one aspect, the present invention relates to a method for production of brewer's wort. Particularly, the present invention relates to a method for production of a brewer's wort comprising adding to a mash, a glucoamylase that is at least 50% identical to the sequence shown in SEQ ID NO: 1.

In accordance with one aspect, the mash is obtainable by grounding a grist comprising malt and/or adjunct. Water may preferably be added to the grist, be preheated in order for the mash to attain the desired mash temperature at the moment of mash forming. If the temperature of the formed mash is below the desired mashing temperature, additional heat is preferably supplied in order to attain the desired process temperature. Preferably, the desired mashing temperature is attained within 15 minutes, or more preferably within 10 minutes, such as within 9, 8, 7, 6, 5, 4, 3, 2 minutes or even more preferably within 1 minute after the mash forming, or most preferably the desired mashing temperature is attained at the mash forming. The temperature profile of the mashing process may be a profile from a conventional mashing process wherein the temperatures are set to achieve optimal degradation of the grist dry matter by the malt enzymes.

The mashing process generally applies a controlled stepwise increase in temperature, where each step favors one enzymatic action over the other, eventually degrading proteins, cell walls and starch. Mashing temperature profiles are generally known in the art. In the present invention the saccharification (starch degradation) step in the mashing process is preferably performed between 60° C. and 66° C., more preferably between 61° C. and 66° C., even more preferably between 62° C. and 66° C., and most preferably between 63° C. and 66° C. In a particular embodiment of the present invention the saccharification temperature is 64° C.

In one aspect, the mashing profile includes a rest (or an extended time) at a temperature at or above 70° C. In several embodiments, the mashing profile includes a rest at a temperature above 70° C., such as above 71° C., such as above 72° C., such as above 73° C., such as above 74° C., such as above 75° C., such as above 76° C., such as above 77° C., such as above 78° C., such as above 79° C., such as above 80° C., such as above 81° C., such as above 82° C., such as above 83° C., such as above 84° C., such as above 85° C., such as, for example, above 86° C. A rest is understood as any extended time where the temperature is kept above this temperature, even though the temperature is not kept constant during this time interval. The extended time could be between 5 minutes (min) to 2 hours, for example, from 5 min to 1.5 hours, e.g., from 10 min to 1 hour, e.g., 10 min to 50 min, e.g., from 15 min to 40 min. The mashing might have one or more than one of such rest periods.

In one aspect, the mashing time is at or above 70° C. for at least 60 minutes, e.g., for at least 65 minutes, e.g., for at least 70 minutes, e.g., for at least 75 minutes, e.g., for at least 80 minutes, e.g., for at least 85 minutes, e.g., for at least 90 minutes, e.g., for at least 95 minutes, e.g., for at least 100 minutes, e.g., for at least 105 minutes, e.g., for at least 110 minutes, e.g., for at least 115 minutes, e.g., for at least 120 minutes.

In one aspect, the mashing time is below 70° C. for less than 60 minutes, e.g., for less than 55 minutes, e.g., for less than 50 minutes, e.g., for less than 45 minutes, e.g., for less than 40 minutes, e.g., for less than 35 minutes.

In one aspect, the invention relates to a method of producing a brewer's wort comprising adding to a mash, a glucoamylase that is active during mashing conditions at temperatures of at least 65° C. In another aspect, the glucoamylase is active during mashing conditions of at least 68° C., e.g., 70° C., e.g., 72° C., for e.g. 75° C., for e.g. 76° C., e.g., 77° C., e.g., 78° C., e.g., 79° C., e.g., 80° C. In one aspect, the invention relates to a glucoamylase that is active during lautering and/or mash filtration.

In one aspect, the mashing process of the present invention includes but not limited to a mashing-off step. In one aspect, the mashing-off step includes but is not limited to incubation of the mash at a temperature of at least 65° C. for at least 20 minutes. In one aspect, the mashing-off step comprises incubation of the mash at a temperature of at least 65° C., e.g., at least 66° C., at least 67° C., at least 68° C., at least 69° C., at least 70° C., at least 71° C., at least 72° C., at least 73° C., at least 74° C. or at least 75° C., at least 76° C., at least 77° C., at least 78° C., at least 79° C., at least 80° C., at least 81° C., at least 82° C., at least 83° C., at least 84° C. or at least 85° C. for at least 20 minutes e.g., at least 25 minutes, at least 30 minutes, at least 35 minutes, at least 40 minutes, at least 45 minutes, at least 50 minutes, at least 55 minutes, at least 60 minutes, at least 65 minutes, at least 70 minutes, at least 75 minutes, at least 80 minutes, at least 85 minutes, at least 90 minutes, at least 95 minutes, at least 100 minutes, at least 105 minutes, at least 110 minutes, at least 115 minutes, at least 120 minutes, at least 125 minutes, at least 130 minutes, at least 135 minutes, at least 140 minutes, at least 145 minutes such as at least 150 minutes. In a particular embodiment, the mashing-off is done at 75° C. for 120 minutes.

In one aspect, the pH of the mash is in the range of about 4.6 to about 6.4. In another aspect, the pH is in the range of about 4.6 to 6.2, such as in the range between pH about 4.8 to about 6.0, preferably in the range between pH about 5.0 to about 6.0, more preferably in the range between pH about 5.0 to about 5.8, even more preferably in the range between pH about 5.2 to about 5.6. In one aspect, the grist further comprises malt.

The malt is preferably derived from one or more of the grains selected from the list consisting of corn, barley, wheat, rye, sorghum, millet and rice. Preferably, the malt is barley malt. The grist preferably comprises from 0.5% to 99%, preferably from 1% to 95%, more preferably from 5% to 90%, for example, from 10% to 80%, e.g., from 20% to 70%, e.g., from 30% to 70%, e.g., from 30% to 60%, even more preferably from 35% to 55% malt.

In addition to malted grain, the grist may preferably comprise adjunct such as unmalted corn, or other unmalted grain, such as barley, wheat, rye, oat, corn, rice, milo, millet and/or sorghum, or raw and/or refined starch and/or sugar containing material derived from plants like wheat, rye, oat, corn, rice, milo, millet, sorghum, potato, sweet potato, cassava, tapioca, sago, banana, sugar beet and/or sugar cane. For the invention, adjuncts may be obtained from tubers, roots, stems, leaves, legumes, cereals and/or whole grain. Preferred is adjunct obtained from corn and/or rice, more preferred the adjunct is rice starch, corn starch and/or corn grits. The mash preferably comprises from 1% to 80%, preferably from 10% to 70%, more preferably from 20% to 65% adjunct starch. Adjunct may also comprise readily fermentable carbohydrates such as sugars or syrups and may be added to the malt mash before, during or after the mashing process of the invention but is preferably added after the mashing process. Prior to forming the mash, the malt and/or adjunct are preferably milled and most preferably dry or wet milled. In one aspect, the adjunct has a high gelatinization temperature. In another aspect, the adjunct is not gelatinized prior to mashing.

In one aspect, the mash is comprised of at least 20% of adjuncts which have a starch gelatinization temperature, preferably onset gelatinization temperature, of at least 67° C. In another aspect, the mash is comprised of at least 25%, e.g. at least 30%, at least 35%, at least 40%, at least 45%, at least 50%, at least 55%, at least 60% such as at least 65% adjuncts which have a starch gelatinization temperature, preferably onset gelatinization temperature, of at least 67° C. such as for example, at least 68° C. at least 67° C., such as at least 68° C., e.g., at least 69° C., e.g., at least 70° C., e.g., at least 71° C., e.g., above 72° C., e.g., at least 73° C., e.g., at least 74° C., e.g., at least 75° C., e.g., above 76° C., e.g., above 77° C., such as for example above 78° C.

In one aspect, the mash comprises at least 10% unmalted grains compared to the total grist. In another aspect, the mash comprises at least 15%, e.g. at least 20%, at least 25%, at least 30%, at least 35%, at least 40%, at least 45%, at least 50%, at least 55%, such as at least 60% unmalted grains.

In one aspect of the invention, the adjunct comprises corn. In another aspect of the invention, the mash comprises at least 20% of corn adjunct. In one aspect, the mash comprises at least 25%, e.g., at least 30%, at least 35%, at least 40%, at least 45%, at least 50%, at least 55%, such as at least 60% of corn adjunct.

In one aspect, the corn adjunct is ungelatinized when added to the mash. In one aspect of the invention, the adjunct comprises rice. In another aspect of the invention, the mash comprises at least 20% of rice adjunct. In one aspect, the mash comprises at least 25%, e.g., at least 30%, at least 35%, at least 40%, at least 45%, at least 50%, at least 55%, such as at least 60% of rice adjunct. In one aspect, the rice adjunct is ungelatinized when added to the mash.

In various embodiments, the ungelatinized starch is selected from corn, rice or sorghum or mixtures thereof.

In one aspect, the glucoamylase is exogenously supplied and/or present in the mash. In one aspect, the glucoamylase is introduced at the beginning of mashing. In another aspect, the glucoamylase is introduced during mashing. In another aspect, the glucoamylase is introduced under lautering.

In one preferred embodiment, alpha amylase(s) is further added to the mash. Without being bound by theory, it is believed that the amylase addition will ensure a high brewing yield.

In a preferred aspect, the alpha-amylase has at least 10% residual activity above 75° C., such as at least 10% residual activity above 76° C., such as for example, above 77° C., such as above 78° C., such as above 79° C., such as above 80° C., such as above 82° C.

In another preferred embodiment, the amylase is obtainable from Bacillus or Aspergillus. In a preferred embodiment, the alpha-amylase is at least 50% identical to SEQ ID No 5.

In another preferred embodiment, further enzyme(s) is added to the mash, said enzyme(s) including but not limited to isoamylase, protease, cellulase, glucanase, laccase, xylanase, lipase, phospholipolase, phytase, phytin and esterase.

In one aspect of the method, the further enzyme added includes but is not limited to a pullulanase.

In one aspect of the method, the further enzyme added includes but is not limited to a protease.

In one aspect of the method, the further enzyme added includes but is not limited to a cellulase.

In one aspect of the method, the further enzyme added includes but is not limited to a xylanase.

In one aspect of the method, the further enzyme added includes but is not limited to a lipase.

In one aspect of the method, the further enzyme added includes but is not limited to a glucanase, preferably but not limited to beta glucanase.

In one aspect, practicing the method of the invention leads to increased levels of glucose in the wort. In one aspect, the increase in glucose is at least 1% e.g., at least 2%, at least 3%, at least 4%, at least 5%, at least 6%, at least 7%, at least 8%, at least 9%, at least 10% when compared to the wort produced in the absence of the such a glucoamylase.

In one aspect, practising the method of the invention leads to a wort which has at least 70% glucose when compared to the total carbohydrate content of the wort. In another aspect, the wort has at least 71% glucose, e.g., at least 72%, at least 73%, at least 74%, at least 75%, at least 76%, at least 77%, at least 78%, at least 79%, at least 80%, e.g., at least 81% glucose, e.g., at least 82%, at least 83%, at least 84%, at least 85%, at least 86%, at least 87%, at least 88%, at least 89%, at least 90%, at least 91%, at least 92%, at least 92.5%, at least 93%, at least 93.5%, such as at least 94% glucose when compared to the total carbohydrate content of the wort.

In one aspect, practising the method of the invention leads to a wort which has less than 20% dextrins (DP4+) when compared to the total carbohydrate content of the wort. In one aspect, the wort has less than 19% DP4+, such as for example, less than 18%, less than 17%, less than 16%, less than 15%, less than 14%, less than 13%, less than 12%, less than 11%, less than 10%, less than 9%, less than 8%, less than 7%, less than 6%, less than 5%, less than 4%, less than 3%, such as less than 2.5% dextrins (DP4+).

In one aspect, the mash and/or the wort comprise no added glucose syrup.

In another aspect, practicing the method of the invention leads to additional glucose formation at temperatures between 68° C. to 90° C. In one aspect, the additional glucose formed at temperatures between 68° C. to 90° C. is at least 1% e.g., at least 2%, at least 3%, at least 4%, at least 5%, at least 6%, at least 7%, at least 8%, at least 9%, at least 10% when compared to the wort produced in the absence of the such a glucoamylase.

In one aspect, practicing the method of the invention leads to decreased concentration of maltose in the wort. In one aspect, the concentration of maltose is decreased by at least 0.5%, e.g., at least 1% e.g., at least 2%, at least 3%, at least 4%, at least 5%, when compared to the wort produced in the absence of such a glucoamylase.

In one aspect, practicing the method of the invention leads to increased concentration of glucose and decreased concentration of maltose in the wort. In one aspect, the concentration of glucose is increased by at least 1% e.g., at least 2%, at least 3%, at least 4%, at least 5%, at least 6%, at least 7%, at least 8%, at least 9%, at least 10% and the concentration of maltose is decreased by at least 0.5%, e.g., at least 1% e.g., at least 2%, at least 3%, at least 4%, at least 5%, when compared to the wort produced in the absence of the such a glucoamylase.

In one aspect, the method of the invention leads to shortened mashing times. In one aspect, the method leads to decrease in mashing time by at least 5 minutes e.g., at least 10 minutes, at least 15 minutes, at least 20 minutes, at least 25 minutes more preferably by at least 30 minutes compared to the method done in the absence of such a glucoamylase.

In one aspect, the method of the invention leads to mashing times that are below 181 minutes. In another aspect, the mashing time is below 160 minutes, e.g. below 140 minutes, e.g. below 120 minutes, such as below 110 minutes, e.g. below 100 minutes, such as e.g., below 90 minutes, below 80 minutes, below 70 minutes, below 60 minutes, below 50 minutes, e.g., below 40 minutes.

In one aspect, the method of the invention leads to shorter saccharification times, i.e., the time during mashing where the temperature is between 60° C. and 66° C. In one aspect, the time is less than 60 minutes. In another aspect, the time is less than 58 minutes, e.g., less than 56 minutes, less than 54 minutes, less than 52 minutes, less than 50 minutes, less than 48 minutes, less than 46 minutes, less than 44 minutes, less than 42 minutes, less than 40 minutes, less than 38 minutes, less than 36 minutes, less than 34 minutes, less than 32 minutes, less than 30 minutes, less than 28 minutes, less than 26 minutes, less than 24 minutes, less than 22 minutes, such as less than 20 minutes.

In another aspect, the method of the invention leads to lower enzyme dosage, particularly the glucoamylase dosage (AGU/g grist). In one aspect, the glucoamylase dosage is reduced by at least 10% e.g. at least 15%, at least 20%, at least 25%, at least 30%, at least 35%, at least 40%, at least 45%, at least 50%, at least 55%, at least 60%, at least 65%, at least 70%, such as at least 75% when compared to a method done with a glucoamylase found in the prior art.

During the mashing process, starch extracted from the grist is gradually hydrolyzed into fermentable sugars and smaller dextrins. Preferably, the mash is starch negative to iodine testing, before extracting the wort.

Obtaining the wort from the mash typically includes straining the wort from the spent grains, i.e., the insoluble grain and husk material forming part of grist. Hot water may be run through the spent grains to rinse out, or sparge, any remaining extract from the grist. Optionally the application of a thermostable cellulase in the process of the present invention results in efficient reduction of beta-glucan level facilitating wort straining thus ensuring reduced cycle time and high extract recovery. Preferably, the extract recovery is at least 80%, preferably at least 81%, more preferably at least 82%, even more preferably at least 83%, such as at least 84%, at least 85%, at least 86%, at least 87%, at least 88%, at least 89%, at least 90%, and most preferably at least 91%.

Following the separation of the wort from the spent grains of the grist, the wort may be used as it is or it may be dewatered to provide a concentrated and/or a dried wort. The concentrated and/or dried wort may be used as brewing extract, as malt extract flavoring, for non-alcoholic malt beverages, malt vinegar, breakfast cereals, for confectionary etc. In a preferred embodiment, the wort is fermented to produce an alcoholic beverage, preferably a beer, e.g., ale, strong ale, bitter, stout, porter, lager, export beer, malt liquor, barley wine, happoushu, high-alcohol beer, low-alcohol beer, low-calorie beer or light beer. Fermentation of the wort may include pitching the wort with a yeast slurry comprising fresh yeast, i.e., yeast not previously used for the invention or the yeast may be recycled yeast. The yeast applied may be any yeast suitable for beer brewing, especially yeasts selected from Saccharomyces spp. such as S. cerevisiae and S. uvarum, including natural or artificially produced variants of these organisms. The methods for fermentation of wort for production of beer are well known to the person skilled in the art.

The process of the invention may include adding silica hydrogel to the fermented wort to increase the colloidal stability of the beer. The processes may further include adding kieselguhr to the fermented wort and filtering to render the beer bright. In one aspect, the invention provides for a beer produced from the wort, such as a beer produced by fermenting the wort to produce a beer. The beer may be any type of beer, e.g., ales, strong ales, stouts, porters, lagers, bitters, export beers, malt liquors, happoushu, high-alcohol beer, low-alcohol beer, low-calorie beer or light beer.

In one aspect, the invention relates to the use of a glucoamylase that has an amino acid sequence which is at least 50% identical to the amino acid sequence shown in SEQ ID NO: 1 in a wort production process.

In one aspect, the invention relates to a wort produced by using a method of this invention. In another aspect, the invention relates to a beer and a method for producing the same using a wort prepared by the method of this invention.

### Enzymes:

The enzymes to be applied in the present invention should be selected for their ability to retain sufficient activity at the process temperature of the processes of the invention, as well as for their ability to retain sufficient activity under the moderately acid pH regime in the mash and should be added in effective amounts. The enzymes may be derived from any source, preferably from a plant or algae, and more preferably from a microorganism, such as from bacteria or fungi.

### Glucoamylase (EC 3.2.1.3)

Glucoamylase may be obtained from a microorganism or a plant. For purposes of the present invention, the term “obtained from” as used herein in connection with a given source shall mean that the polypeptide encoded by a nucleotide sequence is produced by the source or by a strain in which the nucleotide sequence from the source has been inserted. In a preferred aspect, the polypeptide obtained from a given source is secreted extracellularly.

The glucoamylase of the present invention may be of fungal origin. For example, the glucoamylase may be obtained from yeast such as a Candida, Kluyveromyces, Pichia, Saccharomyces, Schizosaccharomyces, or Yarrowia. Preferably the glucoamylase may be obtained from a filamentous fungi such as an Acremonium, Agaricus, Alternaria, Aspergillus, Aureobasidium, Botryosphaeria, Ceriporiopsis, Chaetomidium, Chrysosporium, Claviceps, Cochliobolus, Coprinopsis, Coptotermes, Corynascus, Cryphonectria, Cryptococcus, Diplodia, Exidia, Filibasidium, Fusarium, Gibberella, Holomastigotoides, Humicola, Irpex, Lentinula, Leptospaeria, Magnaporthe, Melanocarpus, Meripilus, Mucor, Myceliophthora, Neocallimastix, Neurospora, Paecilomyces, Penicillium, Phanerochaete, Piromyces, Poitrasia, Pseudoplectania, Pseudotrichonympha, Rhizomucor, Schizophyllum, Scytalidium, Talaromyces, Thermoascus, Thielavia, Tolypocladium, Trichoderma, Trichophaea, Verticillium, Volvariella, or Xylaria polypeptide having glucoamylase activity.

In another preferred aspect, the glucoamylase is obtained from Acremonium cellulolyticus, Aspergillus aculeatus, Aspergillus awamori, Aspergillus fumigatus, Aspergillus foetidus, Aspergillus japonicus, Aspergillus nidulans, Aspergillus niger, Aspergillus oryzae, Chrysosporium keratinophilum, Chrysosporium lucknowense, Chrysosporium tropicum, Chrysosporium merdarium, Chrysosporium inops, Chrysosporium pannicola, Chrysosporium queenslandicum, Chrysosporium zonatum, Fusarium bactridioides, Fusarium cerealis, Fusarium crookwellense, Fusarium culmorum, Fusarium graminearum, Fusarium graminum, Fusarium heterosporum, Fusarium negundi, Fusarium oxysporum, Fusarium reticulatum, Fusarium roseum, Fusarium sambucinum, Fusarium sarcochroum, Fusarium sporotrichioides, Fusarium sulphureum, Fusarium torulosum, Fusarium trichothecioides, Fusarium venenatum, Humicola grisea, Humicola insolens, Humicola lanuginosa, Irpex lacteus, Mucor miehei, Myceliophthora thermophila, Neurospora crassa, Penicillium funiculosum, Penicillium purpurogenum, Phanerochaete chrysosporium, Penicillium thomii, Penicillium oxalicum, Thielavia achromatica, Thielavia albomyces, Thielavia albopilosa, Thielavia australeinsis, Thielavia fimeti, Thielavia microspora, Thielavia ovispora, Thielavia peruviana, Thielavia spededonium, Thielavia setosa, Thielavia subthermophila, Thielavia terrestris, Trichoderma harzianum, Trichoderma koningii, Trichoderma longibrachiatum, Trichoderma reesei, or Trichoderma viride.

Glucoamylases obtainable from organisms may also be converted into a glucoamylase of the invention by means of protein engineering using techniques known in the art. [For example, Lehmann and Wyss, 2001, Curr Opin Biotechnol., 12(4):371-5.]

In a more preferred aspect, the glucoamylase is obtained from Penicillium oxalicum. In a most preferred aspect, the glucoamylase is a Penicillium oxalicum polypeptide having glucoamylase activity, e.g., the polypeptide comprising SEQ ID NO: 1.

It will be understood that for the aforementioned species the invention encompasses both the perfect and imperfect states, and other taxonomic equivalents, e.g., anamorphs, regardless of the species name by which they are known. Those skilled in the art will readily recognize the identity of appropriate equivalents.

Strains of these species are readily accessible to the public in a number of culture collections, such as the American Type Culture Collection (ATCC), Deutsche Sammlung von Mikroorganismen and Zellkulturen GmbH (DSMZ), Centraalbureau Voor Schimmelcultures (CBS), and Agricultural Research Service Patent Culture Collection, Northern Regional Research Center (NRRL).

Furthermore, such polypeptides may be identified and obtained from other sources including microorganisms isolated from nature (e.g., soil, composts, water, etc.) using the techniques known in the art, e.g., using the polynucleotide coding for a polypeptide as a probe. Techniques for isolating microorganisms from natural habitats are well known in the art. The polynucleotide may then be obtained by similarly screening a genomic or cDNA library of such a microorganism. Once a polynucleotide encoding a polypeptide has been detected with the probe(s), the polynucleotide can be isolated or cloned by utilizing techniques that are well known to those of ordinary skill in the art (see, e.g., Sambrook et al. (1989) Molecular cloning: A laboratory manual, Cold Spring Harbor lab., Cold Spring Harbor, N.Y.).

In one aspect, the glucoamylase has an amino acid sequence which is at least 50%, e.g. at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98% or even at least 99% identical to the amino acid sequence shown in SEQ ID NO: 1.

In a preferred embodiment, the glucoamylase has an amino acid sequence which differs by no more than 100 amino acids, preferably by no more than 80 amino acids, more preferred by no more than 50 amino acids, more preferably by no more than 30 amino acids, even more preferably by no more than 20 amino acids, and most preferably by no more than 10 amino acids from the amino acid sequence of SEQ ID NO: 1.

In one aspect, the invention relates to the use of a glucoamylase that has an amino acid sequence which is at least 50% identical e.g. at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98% or even at least 99% to the amino acid sequence shown in SEQ ID NO: 1 in a wort production process.

In one aspect, the glucoamylase has a temperature optimum of at least 65° C. In another aspect, the temperature optimum is at least 66° C., e.g., at least 67° C. such as at least 68° C., at least 69° C., at least 70° C., at least 71° C., at least 72° C., at least 73° C., at least 74° C., at least 75° C., at least 76° C., at least 77° C., at least 78° C., at least 79° C., such as at least 80° C. determined by the enzyme's ability to release glucose during incubation at 32-85 C at pH 5.0 to 6.0 for 1 hour. In one aspect, the incubation pH is 6.0. In another aspect, the pH is 5.8. In one aspect, the pH is 5.6. In another aspect, the pH is 5.4. In one aspect, the pH is 5.2. In another aspect, the pH is 5.0.

In one embodiment, the glucoamylase has a temperature optimum of around 65-75° C. determined by the enzyme's ability to release glucose during incubation at 32-85° C. at pH 6.0 for 1 hour as described in Example no: 1.

In one embodiment, the glucoamylase has at 80° C. a residual activity of at least 10% such as at least 11%, e.g., 12%, e.g., 13%, e.g., 14%, e.g., 15%, e.g., 16%, e.g., 17%, e.g., 18%, e.g., 19%, e.g., 20% such as at least 21%, e.g., 22%, e.g., 23%, e.g., 24%, e.g., 25%, e.g., 26%, e.g., 27%, e.g., 28%, e.g., 29%, e.g., 30%, e.g., 31%, e.g., 32% as determined by the enzyme's ability to release glucose at pH 6.0 measured by the formation of glucose using maltodextrin as a substrate as described in Example no: 1.

In one aspect, the glucoamylase is added in a concentration of about 0.0005 to about 200 mg enzyme protein per gram of total grist, preferably about 0.001 to about 100, more preferably about 0.01 to about 50, even more preferably about 0.05 to about 2.0 mg of enzyme protein (EP) per gram of total weight of the grist.

In one aspect, the concentration of glucoamylase added is less than 0.4 mg enzyme protein (EP) per gram of the total grist. In another aspect, the concentration of glucoamylase is less than 0.35, such as less than 0.3, such as less than 0.25, such as less than 0.2 such as less than 0.15 mg enzyme protein (EP) per gram of the total grist.

In one aspect, the glucoamylase is dosed less than 5 AGU/g grist. In some embodiments, the glucoamylase is dosed less than 4.5 AGU/g grist, such as for example, less than 4.0 AGU/g grist, e.g., less than 3.5 AGU/g grist, e.g., less than 3 AGU/g grist, e.g., less than 2.5 AGU/g grist, e.g., less than 2 AGU/g grist, e.g., less than 1.5 AGU/g grist, such as less than 1 AGU/g grist.

### Pullulanase (EC 3.2.1.41)

Pullulanase (EC 3.2.1.41) catalyzes the hydrolysis of (1->6)-alpha-D-glucosidic linkages in pullulan, amylopectin and glycogen, and in the alpha- and beta-limit dextrins of amylopectin and glycogen. These enzymes were formerly EC 3.2.1.69. They are alternatively called Alpha-dextrin endo-1,6-alpha-glucosidase or Amylopectin 6-glucanohydrolase or Debranching enzyme or Limit dextrinase or Pullulan 6-glucanohydrolase.

The pullulanase according to the present invention is preferably pullulanase from e.g. Pyrococcus or Bacillus, such as Bacillus acidopullulyticus e.g. the one described in Kelly et al., 1994, FEMS Microbiol. Letters 115: 97-106, or a pullulanase available from Novozymes A/S as Promozyme 400L. The pullulanase may also be from Bacillus naganoencis, or Bacillus deramificans e.g. such as derived from Bacillus deramificans (U.S. Pat. No. 5,736,375). The pullulanase may also be an engineered pullulanases from, e.g. a Bacillus strain.

Other pullulanases may be derived from Pyrococcus woesei described in PCT/DK91/00219, or the pullulanase may be derived from Fervidobacterium sp. Ven 5 described in PCT/DK92/00079, or the pullulanase may be derived from Thermococcus celer described in PCT/DK95/00097, or the pullulanase may be derived from Pyrodictium abyssei described in PCT/DK95/00211, or the pullulanase may be derived from Fervidobacterium pennavorans described in PCT/DK95/00095, or the pullulanase may be derived from Desulforococcus mucosus described in PCT/DK95/00098.

Most preferably the pullulanase is derived from Bacillus acidopullulyticus. A preferred pullulanase enzyme to be used in the processes and/or compositions of the invention is a pullulanase having an amino acid sequence which is at least 50%, such as at least 55%, such as at least 60%, such as at least 65%, such as at least 66%, such as at least 70%, such as at least 75%, such as at least 80%, such as at least 85%, such as at least 86%, such as at least 87%, such as at least 88%, such as at least 89%, such as at least 90%, such as at least 91%, such as at least 92%, such as at least 93%, such as at least 94%, such as at least 95%, such as at least 96%, such as at least 97%, such as at least 98%, such as at least 99% or even 100% identical to the sequence of the pullulanase 3 disclosed in WO2009/075682.

The pullulanase may be added in effective amounts well known to the person skilled in the art. In one aspect, the pullulanase is added in dosage of 0.1 to 3 PUN/g DM, such as 0.2 to 2.9, such as 0.3 to 2.8, such as 0.3 to 2.7 such as 0.3 to 2.6 such as 0.3 to 2.5 such as 0.3 to 2.4, such as 0.3 to 2.3, such as 0.3 to 2.2, such as 0.3 to 2.1, such as 0.3 to 2.0, such as 0.3 to 1.9, such as 0.3 to 1.8, such as 0.3 to 1.7, such as 0.3 to 1.6, most preferably pullulanase is added in dosage such as 0.3 to 1.5, preferably 0.4 to 1.4, more preferably 0.5 to 1.3, more preferably 0.6 to 1.2, more preferably 0.7 to 1.1, more preferably 0.8 to 1.0, more preferably 0.9 to 1.0. In a particular embodiment of the invention the enzyme is added in 0.3 PUN/g DM, such as 0.4 PUN/g DM, such as 0.5 PUN/g DM in a particularly preferred embodiment of the invention the enzymes dose is not larger than 1 PUN/g DM.

One pullulanase unit (PUN) is the amount of enzyme which, under standard conditions (i.e. after 30 minutes reaction time at 40° C. and pH 5.0; and with 0.2% pullulan as substrate) hydrolyzes pullulan, liberating reducing carbohydrate with a reducing power equivalent to 1 micromol glucose per minute. Pullulanase activity is by measured by detection of increased reducing sugar capacity (Somogyi-Nelson reaction) in the following conditions: Substrate: 0.2% pullulan, pH 5.0, reaction 20 time 30 minutes. The samples are analyzed by spectrophotometer at OD 520 nm.

In one aspect, the invention of the method comprises both a glucoamylase and a pull ulanase.

### Alpha-Amylase (EC 3.2.1.1)

A particular alpha-amylase enzyme to be used in the processes and/or compositions of the invention may be a Bacillus alpha-amylase. Well-known Bacillus alpha-amylases include alpha-amylase derived from a strain of B. licheniformis, B. amyloliquefaciens, and B. stearothermophilus. In one aspect of the present invention, a contemplated Bacillus alpha-amylase is an alpha-amylase as defined in WO 99/19467 on page 3, line 18 to page 6, line 27. Preferably the α-amylase has at least 50%, more preferably at least 60%, more preferably at least 70%, more preferably at least 80%, preferably at least 85%, more preferably at least 90%, preferably at least 91%, preferably at least 92%, preferably at least 93%, preferably at least 94%, more preferably at least 95%, preferably at least 96%, preferably at least 97%, more preferably at least 98%, and most preferably at least 99% identity to the amino acid sequence shown in the amino acid sequence disclosed as SEQ ID NO: 3 in WO 99/19467 with the mutations: I181*+G182*+N193F. Also contemplated is the amylase Termamyl® SC from Novozymes A/S. Another particular alpha-amylase to be used in the processes of the invention may be any fungal alpha-amylase, e.g., an alpha-amylase derived from a species within Aspergillus, and preferably from a strain of Aspergillus niger. Especially contemplated are fungal alpha-amylases which exhibit a high identity, i.e., at least 50%, at least 55%, at least 60%, at least 65%, at least 70%, at least 75%, at least 80%, at least 85% or even at least 90% identity to the amino acid sequence shown as SEQ ID NO: 1 in WO 2002/038787.

In a preferred embodiment, the alpha-amylase is at least 50% identical to SEQ ID No 5, e.g. at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98% or even at least 99% identical to the amino acid sequence shown in SEQ ID NO: 5.

The amount of alpha amylase to be added depends on various parameters and is generally known to the person skilled in the art. In one aspect, the alpha amylase activity in the mash is 0.1-1.0 KNU/g, more preferably 0.2-0.4 KNU/g, and most preferably 0.25-0.35 KNU/g dry weight cereal(s). One Kilo Novo alpha amylase Unit (KNU) equals 1000 NU. One KNU is defined as the amount of enzyme which, under standard conditions (i.e. at 37° C.+/−0.05; 0.0003 M Ca2+; and pH 5.6) dextrinizes 5.26 g starch dry substance Merck Amylum solubile.

### Isoamylase (E.C. 3.2.1.68)

Another enzyme applied in the processes and/or compositions of the invention may be an alternative debranching enzyme, such as an isoamylase (E.C. 3.2.1.68). Isoamylase hydrolyzes alpha-1,6-D-glucosidic branch linkages in amylopectin and beta-limit dextrins and can be distinguished from pullulanases by the inability of isoamylase to attack pullulan, and by the limited action on alpha-limit dextrins. Isoamylase may be added in effective amounts well known to the person skilled in the art.

### Protease

Suitable proteases include microbial proteases, such as fungal and bacterial proteases. Preferred proteases are acidic proteases, i.e., proteases characterized by the ability to hydrolyze proteins under acidic conditions below pH 7. The proteases are responsible for reducing the overall length of high-molecular-weight proteins to low-molecular-weight proteins in the mash. The low-molecular-weight proteins are a necessity for yeast nutrition and the high-molecular-weight-proteins ensure foam stability. Thus it is well-known to the skilled person that protease should be added in a balanced amount which at the same time allows ample free amino acids for the yeast and leaves enough high-molecular-weight-proteins to stabilize the foam. In one aspect, the protease activity is provided by a proteolytic enzymes system having a suitable FAN generation activity including endo-proteases, exopeptidases or any combination hereof, preferably a metallo-protease. Preferably, the protease has at least 50%, more preferably at least 60%, more preferably at least 70%, more preferably at least 80%, more preferably at least 85%, more preferably at least 90%, more preferably at least 91%, more preferably at least 92%, more preferably at least 93%, more preferably at least 94%, more preferably at least 95% more preferably at least 96%, more preferably at least 97% more preferably at least 98%, and most preferably at least 99% or even 100% identity to the amino acid sequence shown in SEQ ID NO:6 described in WO99/67370. In another aspect, the protease is Neutrase® available from Novozymes A/S. Proteases may be added in the amounts of, 0.0001-1000 AU/kg DS, preferably 1-100 AU/kg DS and most preferably 5-25 AU/kg dry weight cereal(s).

The proteolytic activity may be determined by using denatured hemoglobin as substrate. In the Anson-Hemoglobin method for the determination of proteolytic activity, denatured hemoglobin is digested, and the undigested hemoglobin is precipitated with trichloroacetic acid (TCA). The amount of the TCA soluble product is determined by using phenol reagent, which gives a blue color with tyrosine and tryptophan. One Anson Unit (AU) is defined as the amount of enzyme which under standard conditions (i.e. 25° C., pH 7.5 and 10 min. reaction time) digests hemoglobin at an initial rate such that there is liberated an amount of TCA soluble product per minute which gives the same colour with phenol reagent as one milliequivalent of tyrosine.

### Cellulase (E.C. 3.2.1.4)

The cellulase may be of microbial origin, such as derivable from a strain of a filamentous fungus (e.g., Aspergillus, Trichoderma, Humicola, Fusarium). Specific examples of cellulases include the endoglucanase (endoglucanase I) obtainable from H. insolens and further defined by the amino acid sequence of FIG. 14 in WO 91/17244 and the 43 kD H. insolens endoglucanase described in WO 91/17243.

A particular cellulase to be used in the processes of the invention may be an endo-glucanase, such as an endo-1,4-beta-glucanase. Especially contemplated is the beta-glucanase shown in SEQ.ID.NO: 2 in WO 2003/062409 and homologous sequences. Commercially available cellulase preparations which may be used include CELLUCLAST®, CELLUZYME®, CEREFLO® and ULTRAFLO® (available from Novozymes A/S), LAMINEX™ and SPEZYME® CP (available from Genencor Int.) and ROHAMENT® 7069 W (available from Rohm, Germany).

Beta-glucanases may be added in the amounts of 1.0-10000 BGXU/kg DS, preferably from 10-5000 BGXU/kg DS, preferably from 50-1000 BGXU/kg DS and most preferably from 100-500 BGXU/kg DS. One Beta Glucanase Unit (BGXU) corresponds to the quantity of enzyme required to produce 1 micromole of reducing sugars per minute under standard conditions (incubation at 30° C. for 10 minutes at pH 4.40).

### Xylanase:

Xylanases are known in the art. In one aspect, xylanase activity is provided by a xylanase from glycosyl hydrolase family 10. In one aspect, the xylanase has at least 50%, more preferably at least 60%, more preferably at least 70%, more preferably at least 80%, more preferably at least 85%, more preferably at least 90%, more preferably at least 91%, more preferably at least 92%, more preferably at least 93%, more preferably at least 94% more preferably at least 95%, more preferably at least 96%, more preferably at least 97% more preferably at least 98%, and most preferably at least 99% or even 100% identity to the xylanase described in WO 94/21785. In another aspect, the xylanase is Shearzyme® from Novozymes A/S. Preferably the xylanase activity in the mash is 0.02-0.1 FXU(S)/g, more preferably 0.04-0.08 FXU(S)/g dry weight cereal(s).

The xylanolytic activity can be expressed in FXU(S)-units, determined at pH 6.0 with remazol-xylan (4-O-methyl-D-glucurono-D-xylan dyed with Remazol Brilliant Blue R, Fluka) as substrate. An xylanase sample is incubated with the remazol-xylan substrate. The background of non-degraded dyed substrate is precipitated by ethanol. The remaining blue colour in the supernatant (as determined spectrophotometrically at 585 nm) is proportional to the xylanase activity, and the xylanase units are then determined relatively to an enzyme standard at standard reaction conditions, i.e. Substrate concentration 0.45% w/v, Enzyme concentration 0.04-0.14 FXU(S)/mL at 50.0° C., pH 6.0, and in 30 minutes reaction time. Xylanase activity in FXU(S) is measured relative to a Novozymes FXU(S) enzyme standard (obtainable from Novozymes), comprising the monocomponent xylanase preparation, Shearzyme® from Aspergillus aculeatus.

### Lipase:

Lipases are known in the art. In one embodiment, the lipase activity is provided by a lipase having activity to triglycerides and/or galactolipids and/or phospholipids. Preferably, the lipase activity is provided by a lipase from Fusarium (including F. oxysporum and F. heterosporum), Aspergillus (including A. tubigensis), Rhizopus (including R. oryzae) or Thermomyces (including T. lanuginosus) or a variant of these. An example is Lipopan X (Lipopan Xtra), a variant of the Thermomyces lanuginosus lipase with the substitutions G91A+D96W+E99K+P256V+G263Q+L264A+I265T+G266D+T267A+L269N+270A+271G+272G+273F (+274S), described in WO2004099400A2. In another aspect, the lipase is a lipase/phospholipase from Fusarium oxysporum, described in EP 869167, available from Novozymes A/S as Lipopan® F. In a specially preferred embodiment of the invention the lipase is Lipozyme TL® or Lipolase®, this lipase has a significantly good effect on filtration speed and haze reduction and is available from Novozymes A/S, Denmark. The lipase may also be Lipex®, a variant of Lipozyme, available from Novozymes A/S Denmark. The lipases degrade the lipid from barley e.g. the triglycerides into partial glycerides and free fatty acids. This leads to a lower turbidity and much improved mash filtration and lautering properties. Preferably, the lipase activity in the mash is 0-50 LU/g, such as 0-40 LU/g, such as 0-30 LU/g, such as 0-20 LU/g dry weight cereal(s). One Lipase Unit (LU) is the amount of enzyme which liberates 1 micromole of titrable butyric acid per minute at 30.0° C.; pH 7.0; with Gum Arabic as emulsifier and tributyrine as substrate.

The enzymes may be added as enzyme compositions. They may consist of one enzyme or more than one enzyme or more than one enzyme compositions. The enzyme composition, in addition to the enzyme(s), may also contain at least one other substance, for example but not limited to buffer, surfactants etc. The enzyme compositions may be in any art-recognized form, for example, solid, liquid, emulsion, gel, or paste. Such forms are known to the person skilled in the art. In one aspect of the invention more than one enzyme composition, each containing different enzymes may be added. In another aspect of the invention, one enzyme composition containing all the necessary enzymes may be added. In yet another aspect of the invention, one enzyme composition containing a few of the enzymes and at least one another composition containing some or all of the rest of the enzymes may be added. The enzymes may be added at the same time or in sequence one after another or even as a combination of two enzymes and one enzyme separately, one after the other.

The invention is further illustrated in the following examples, which are not intended to be in any way limiting to the scope of the invention as claimed.

### Materials and Methods:

### Glucoamylase Activity:

Glucoamylase activity may be measured in AGU Units.
The Glucoamylase Unit (AGU) is defined as the amount of enzyme, which hydrolyzes 1 micromole maltose per minute under the standard conditions (37° C., pH 4.3, substrate: maltose 100 mM, buffer: acetate 0.1 M, reaction time 6 minutes as set out in the glucoamylase incubation below), thereby generating glucose.

Glucoamylase incubation:

| | |
|---|---|
| Substrate: | maltose 100 mM |
| Buffer: | acetate 0.1M |
| pH: | 4.30 ± 0.05 |
| Incubation temperature: | 37° C. ± 1 |
| Reaction time: | 6 minutes |
| Enzyme working range: | 0.5-4.0 AGU/mL |

The analysis principle is described by 3 reaction steps:

Step 1 is an enzyme reaction:

Glucoamylase, EC 3.2.1.3 (exo-alpha-1,4-glucan-glucohydrolase), hydrolyzes maltose to form alpha-D-glucose. After incubation, the reaction is stopped with NaOH.
Step 2 and 3 result in an endpoint reaction:
Glucose is phosphorylated by ATP, in a reaction catalyzed by hexokinase. The glucose-6-phosphate formed is oxidized to 6-phosphogluconate by glucose-6-phosphate dehydrogenase. In this same reaction, an equimolar amount of NAD+ is reduced to NADH with a resulting increase in absorbance at 340 nm. An autoanalyzer system such as Konelab 30 Analyzer (Thermo Fisher Scientific) may be used.

Colour reaction

| | |
|---|---|
| Tris | approx. 35 mM |
| ATP | 0.7 mM |
| NAD⁺ | 0.7 mM |
| Mg²⁺ | 1.8 mM |
| Hexokinase | >850 U/L |
| Glucose-6-P-DH | >850 U/L |
| pH | approx. 7.8 |
| Temperature | 37.0° C. ± 1.0° C. |
| Reaction time | 420 sec |
| Wavelength | 340 nm |

Chemicals used as buffers and substrates were commercial products of at least reagent grade.

### Enzymes:

The glucoamylases of SEQ ID No: 1, SEQ ID No: 2, SEQ ID No: 3 and SEQ ID No: 4 and the alpha amylase of SEQ ID No: 5 were made using standard recombinant techniques, e.g., as found in WO 2011/127802.
Attenuzyme Flex®—a combination of a glucoamylase, an alpha amylase and a pullulanase is a commercial enzyme composition available from Novozymes A/S, Denmark.

### EXAMPLES

### Example 1

### Temperature Optimum of Glucoamylases

The temperature optimum of glucoamylase of various sequences was determined by the enzymes' ability of releasing glucose during incubation at 32 to 85° C. at pH 6.0. 4 different glucoamylases SEQ ID No: 1, SEQ ID No: 2, SEQ ID No: 3, SEQ ID No: 4 were used. 10 μL of enzyme solution (0.5 mg glucoamylase/mL in 10 mM NaOAc buffer pH 6.0 with 0.02% Triton X-100) was mixed with 190 μL substrate solution (10.5% maltodextrin DE11 in 50 mM NaOAc). The mixture was incubated at 32, 55, 60, 65, 70, 80 or 85° C. for 1 hour. After incubation 10 μL of this sample was mixed with 190 μL Milli-Q water (×20 dilution) for all samples except the 32° C. incubated sample was only diluted ×5. The glucose concentration (mg/mL) in the sample was determined by the enzymatic muratose-GOD assay (Wako Autokit Glucose, 439-90901).

10 μL of the diluted sample was transferred to a 96 well plate, 200 μL stop reagent was added and absorbance measured at 505 nm. Absorbance was converted to mg/mL glucose applying a glucose standard curve. The results are tabulated in table 1 below:

TABLE 1
Temperature optimum of glucoamylases measured at pH 6.0 by the formation of
glucose (mg/mL) using maltodextrin as substrate.

| | SEQ ID No 3 | | SEQ ID No 1 | | SEQ ID No 2 | | SEQ ID No 4. | |
|---|---|---|---|---|---|---|---|---|
| | | Residual | | Residual | | Residual | | Residual |
| | | activity in | | activity in | | activity in | | activity in |
| | mg/mL | % (max = | mg/mL | % (max = | mg/mL | % (max = | mg/mL | % (max = |
| ° C. | glucose | 100%) | glucose | 100%) | glucose | 100%) | glucose | 100%) |
| 32 | 3.62 | 17.24 | 3.84 | 15.04 | 3.36 | 26.99 | 3.80 | 20.45 |
| 55 | 15.85 | 75.48 | 15.25 | 59.71 | 10.55 | 84.74 | 14.71 | 79.17 |
| 60 | 20.44 | 97.33 | 19.82 | 77.60 | 12.45 | 100.00 | 18.58 | 100.00 |
| 65 | 21.0 | 100.00 | 22.57 | 88.37 | 10.11 | 81.20 | 16.63 | 89.50 |
| 70 | 14.47 | 68.90 | 25.54 | 100.00 | 2.31 | 18.55 | 5.75 | 30.95 |
| 75 | 3.73 | 17.76 | 23.13 | 90.56 | 0.47 | 3.78 | 1.40 | 7.53 |
| 80 | 1.20 | 5.71 | 8.29 | 32.46 | 0.26 | 2.09 | 0.65 | 3.50 |
| 85 | 0.63 | 3.00 | 1.57 | 6.15 | 0.17 | 1.37 | 0.37 | 1.99 |

From the table, it appears that the glucoamylase of Seq ID No 1 demonstrates a higher temperature optimum (70° C.) than the other glucoamylases measured (60-65° C.).

### Example 2

### Effect of Glucoamylase in Combination with Alpha Amylase in Wort Production

Trials were carried out in lab scale with 50% well modified malt and 50% grist corn grist composition.

The reference (sub trial 1) represents a typical trial using the existing technology where the adjunct is cooked.

For the reference trial, sub-trial 1, the corn grist was ground with a particle size of 0.2 mm and liquefied, e.g. by the following method; milled corn grists are dispersed in water (33% corn grist at 65° C., where after 0.05 KNU/g grist of an alpha amylase of SEQ ID No 5 was added. Tap water is added, the suspension is then heated by 2° C./min to 95° C. At 95° C., it is kept for 30 min before it is cooled to 64° C.). Liquefied corn grist corresponding to 25 g corn grist was mixed with 25 g milled malt (also ground to a particle size of 2 mm), and water was added to give a total volume of 250 ml, 60 ppm CaCl₂ was added and the pH was adjusted to 5.4. The enzyme (see Table 2 below) was added at the start of the mashing which was carried out with a temperature profile consisted of 64° C. hold at 120 min, followed by an increase (1° C./min) to 75° C. which was held for 20 min, and then cooled to 20° C. (3.9° C./min) before the volume was adjusted to 300 gram before it was filtered. The resulting wort was analyzed by HPLC (sugar profile) and Anton Paar (Plato measurement). The result is given in Table 3.

For sub-trial 2-7 the same ratio of malt and corn grist (un-gelatinised and un-liquefied) were used, but the corn grist was mashed directly in (infusion mashing), the mashing temperature profile was modified to take advantage of the thermostability of the glycoamylase, by a 70° C. rest and a shortened 66° C. rest. Furthermore, a 120 min rest at 78° C. was included to simulate the conditions under industrial lautering.

For sub-trial 2-7, 25 g malt and 25 g corn grist were mixed with 200 g water at 66° C. before 60 ppm CaCl₂ was added and the pH was adjusted to 5.4. The enzymes (according to Table 2) were added at the start of the mashing which was carried out with a mashing temperature profile consisted of 66° C. held at 90 min, increase (1° C./min), to 70° C. which was held for 50 min, followed by an increase to 78° C. (1° C./min) which was held for 120 min., and then cooled to 20° C. (3.9° C./min) before the volume was adjusted to 300 gram before it was filtered. The resulting wort was were analyzed by HPLC (sugar profile) and Anton Parr (Plato measurement). The results are given in Table 3.

TABLE 2
Enzyme addition table

| Subtrial | Enzyme | Dose |
|---|---|---|
| 1 | Attenuzyme Flex | 1.5 AGU/g grist |
| 2 | Attenuzyme Flex | 1.5 AGU/g grist |
| 3 | Attenuzyme Flex | 6 AGU/g grist |
| 4 | SEQ ID No 1 | 1 AGU/g grist |
| | SEQ ID No 5 | 0.5 KNU(S)/g grist |
| 5 | SEQ ID No 1 | 1.5 AGU/g grist |
| | SEQ ID No 5 | 0.5 KNU(S)/g grist |
| 6 | SEQ ID No 1 | 2 AGU/g grist |
| | SEQ ID No 5 | 0.5 KNU(S)/g grist |
| 7 | SEQ ID No 1 | 4 AGU/g grist |
| | SEQ ID No 5 | 0.5 KNU(S)/g grist |

TABLE 3
Sugar Profile (% of total) of wort obtained at after filtration.

| | Sugar profile of wort % | | | | Wort density |
|---|---|---|---|---|---|
| Subtrial | DP 1 | DP2 | DP3 | DP4+ | °Plato |
| 1 | 93.0 | 2.7 | 1.7 | 2.6 | 14.1 |
| (reference) | | | | | |
| 2 | 69.9 | 8.2 | 9.4 | 12.5 | 13.4 |
| 3 | 76.6 | 8.3 | 7.0 | 8.0 | 13.6 |
| 4 | 90.8 | 4.2 | 1.9 | 3.1 | 13.9 |
| 5 | 93.5 | 2.5 | 1.5 | 2.5 | 13.9 |
| 6 | 93.7 | 2.3 | 1.6 | 2.4 | — |
| 7 | 91.8 | 4.66 | 1.5 | 2.1 | 13.9 |

The terms “DP1” (Degree of polymerization 1) denotes glucose or fructose, “DP2” denotes maltose (and isomaltose) and DP3 denotes maltotriose (and panose and isopanose). The terms “DP4+” or “DP4/4+” denote dextrin, or maltooligosaccharides of a polymerization degree of 4 or higher which are unfermentable.

From Table 3, it can be see that glucoamylase of Seq ID No 1 performs superior and is able to provide a wort from infusion mashing of 50% corn adjunct with a sugar profile which is comparable to sugar profile of a traditionally (reference experiment) wort obtained with Attenuzyme Flex and liquefied corn adjunct.

Attenuzyme Flex is not able to reach the same low level of DP4+ even when used in elevated dosages (6 AGU/g grist). The Plato level of sub-trial 4-7 are comparable to the Plato level sub trial 2.

### Example 3

### Effect of Glucoamylase in Combination with Alpha-Amylase in Wort Production for Infusion Mashing at Different Mashing-in Temperature Followed by Higher Temperature of Saccharification and Simulated Lautering

Infusion mashing trials were carried out in lab scale with 40% well modified malt and 60% corn grist composition. The enzyme dosing for glucoamylase and alpha-amylase was as described in Table 4.

TABLE 4
Enzyme addition table

| | | | Mashing-in |
|---|---|---|---|
| Sub-trial | Enzyme | Dose | temperature |
| 1 | SEQ ID No 1 | 1.5 AGU/g grist | 55° C. |
| | SEQ ID No 5 | 0.5 KNU(S)/g grist | |
| 2 | SEQ ID No 1 | 1.5 AGU/g grist | 65° C. |
| | SEQ ID No 5 | 0.5 KNU(S)/g grist | |
| 3 | SEQ ID No 1 | 1.5 AGU/g grist | 75° C. |
| | SEQ ID No 5 | 0.5 KNU(S)/g grist | |
| 4 | SEQ ID No 1 | 1.5 AGU/g grist | 78° C. |
| | SEQ ID No 5 | 0.5 KNU(S)/g grist | |

Malt and corn grist were ground with a particle size of 0.2 mm and same ratio of malt and corn grist (un-gelatinised and un-liquefied) were added, where corn grist together with malt were mashed-in directly (infusion mashing). For each sub-trial, 20 g of malt and 30 g of corn grist (total 50 g) were mixed with 200 g of water and 60 ppm of CaCl₂. The starting mashing-in temperature was adjusted to the respective temperature of 55, 65, 75 or 78° C. for each sub-trial, as shown in Table 4. Taking advantage of the thermostability of the glycoamylase and alpha-amylase, higher saccharification temperature at 78° C. was employed and further 80 min rest at 78° C. was included to simulate the conditions under industrial lautering.

The enzymes (according to Table 4) were added at the start of the respective mashing-in temperature (55-78° C.) held at 60 min, followed by 78° C. held for 60 min and continued at 78° C. which was held for 80 min to simulate industrial lautering, and finally cooled to 20° C. (3.9° C./min). After termination of incubation, the weight of each sample was adjusted to 300 gram and subjected to filtration with filter paper to separate wort from insoluble compounds. The resulting wort was analyzed by HPLC (sugar profile) and Anton Parr (Plato measurement). The results are presented in Table 5.

TABLE 5
Sugar Profile (% of total) of wort after
filtration, as analysed by HPLC

| | Sugar profile of wort, % | | | | Wort density |
|---|---|---|---|---|---|
| Sub-trial | DP 1 | DP2 | DP3 | DP4+ | °Plato |
| 1 | 91.5 | 3.0 | 1.3 | 4.2 | 14.19 |
| 2 | 91.9 | 3.1 | 1.4 | 3.5 | 14.13 |
| 3 | 94.9 | 1.5 | 1.0 | 2.6 | 13.87 |
| 4 | 95.2 | 1.3 | 0.9 | 2.6 | 14.02 |

The terms “DP1” (Degree of polymerization 1) denotes glucose or fructose, “DP2” denotes maltose (and isomaltose) and DP3 denotes maltotriose (and panose and isopanose). The terms “DP4+” or “DP4/4+” denote dextrin, or maltooligosaccharides of a polymerization degree of 4 or higher which are unfermentable.

As shown in Table 5, infusion mashing of 60% corn adjunct plus 40% malt using glucoamylase of Seq ID 1 combined with alpha-amylase Seq ID 5 produced substantially high DP1 yield and low DP2, DP3 and DP4+ concentrations especially at high mashing-in temperature 75° C., sub-trials 3 and 4). With lower mashing-in temperature 65° C., sub-trial 1 and 2) showed comparable sugar profiles and noticeably higher Plato level. These results demonstrate the superior performance of glucoamylase Seq ID 1 combined with alpha-amylase Seq ID 5 for infusion mashing with remarkable sugar profiles and comparable or higher Plato level than traditional method of cooking corn adjunct with mashing and saccharification using Attenuzyme Flex (Table 3, reference experiment).

### Example 4

### Effect of Glucoamylase in Combination with Alpha-Amylase in Wort Production for Infusion Mashing at 65° C. Mashing with Different Time Followed by Higher Temperature of Saccharification and Simulated Lautering

Infusion mashing trials were carried out in lab scale with 40% well modified malt and 60% grist corn grist composition. The enzyme dosing for glucoamylase and alpha-amylase was as described in Table 6.

TABLE 6
Enzyme addition table

| Sub-trial | Mashing-in time (min) | Enzyme, dose |
|---|---|---|
| 1 | 10 | SEQ ID No 1, 1.5 AGU/g grist + |
| 2 | 20 | SEQ ID No 5, 1.0 KNU(S)/g grist |
| 3 | 30 | |
| 4 | 40 | |
| 5 | 50 | |
| 6 | 60 | |

For sub-trials 1-6, malt and corn grist were ground with a particle size of 0.2 mm, and same ratio of malt and corn grist (un-gelatinised and un-liquefied) were added, where corn grist together with malt were mashed-in directly (infusion mashing). For each sub-trial, 20 g of malt and 30 g of corn grist (total 50 g) were mixed with 200 g of water, and 60 ppm CaCl₂ was added. The mashing-in temperature was adjusted to 65° C. As shown in Table 6, sub-trials 1-6 were added with the same glucoamylase and alpha-amylase dosages, and mashing was conducted at 65° C. on each sub-trial at the respective time of 10 to 60 min. Taking advantage of the thermostability of the glycoamylase and alpha-amylase, higher saccharification temperature at 75° C. was employed for 90 min., and further 80 min. rest at 78° C. was included to simulate the conditions under industrial lautering.

The enzymes (according to Table 6) were added at the start of the mashing-in and held at 65° C. for 10, 20, 30, 40, 50 or 60 min., increased (1° C./min.) to 75° C. which was held for 90 min. and continued at 78° C. which was held for 80 min. to simulate industrial lautering, and then cooled to 20° C. (3.9° C./min.). After termination of incubation, the weight of each sample was adjusted to 300 gram and subjected to filtration with filter paper to separate wort from insoluble compounds. The resulting wort was analyzed by HPLC (sugar profile) and Anton Parr (Plato measurement). The result is given in Table 7.

TABLE 7
Sugar Profile (% of total) of wort after
filtration, as analysed by HPLC

| | Sugar profile of wort, % | | | | Wort density |
|---|---|---|---|---|---|
| Subtrial | DP 1 | DP2 | DP3 | DP4+ | °Plato |
| 1 | 92.6 | 3.4 | 1.5 | 2.5 | 14.00 |
| 2 | 92.5 | 3.5 | 1.5 | 2.5 | 14.01 |
| 3 | 92.6 | 3.6 | 1.4 | 2.4 | 14.01 |
| 4 | 92.4 | 3.7 | 1.4 | 2.4 | 14.02 |
| 5 | 92.5 | 3.7 | 1.4 | 2.4 | 14.00 |
| 6 | 92.4 | 3.8 | 1.4 | 2.4 | 14.00 |

As shown in Table 7, mashing-in at 65° C. for 10 to 60 min. showed similar sugars (DP1-DP4+) concentrations and Plato yield. The Plato and DP1 yields were reasonably high and comparatively low DP4+. These results demonstrated that infusion mashing using glucoamylase Seq ID 1 combined with alpha-amylase Seq ID 5 may shorten the 65° C. mashing-in time from 60 min. to 30 min. or less.

1. A method of producing a brewer's wort comprising
a) Providing a grist comprising a starch source with ungelatinized starch with a gelatinization temperature above 68° C.;
b) adding to a mash comprising the grist, a glucoamylase that has at least 10% residual activity at 80° C., and
c) obtaining a wort.

2. The method according to claim 1, wherein the mashing is done below the gelatinization temperature of the ungelatinized starch and mashing off is done above the gelatinization temperature.

3. The method according to claim 1, wherein the grist comprises malt.

4. The method according to claim 1, wherein the grist comprises at least 25% W/W of the ungelatinized starch.

5. The method according to claim 1, wherein the ungelatinized starch is selected from corn, rice or sorghum or mixtures thereof.

6. The method according to claim 1, wherein the glucoamylase is at least 50% identical to SEQ ID NO: 1.

7. The method according to claim 1, wherein the glucoamylase is dosed in less than 5 AGU/g grist.

8. The method according to claim 1, further comprising adding an alpha-amylase.

9. The method according to claim 8, wherein the alpha-amylase has at least 10% residual activity at 75° C.

10. The method according to claim 8, wherein the alpha-amylase is at least 50% identical to SEQ ID NO: 5.

11. The method according to claim 1, wherein the wort has more than 70% glucose.

12. The method according to claim 1, wherein the wort has less than 20% dextrins (DP4+).

13. The method according to claim 2, wherein the mashing profile includes a rest at a temperature above 70° C.

14. The method according to claim 2, wherein the total mashing time is less than 181 min.

15. The method according to claim 1, wherein the glucoamylase has a temperature optimum of above 65° C.

16. The method according to claim 1, further comprising adding an enzyme selected from the group consisting of a pullulanase, a protease, a xylanase, a lipase, a cellulase, an amylase and a beta glucanase.

17. A method according to claim 1, wherein the wort is fermented to a beer.
